(19) United States
(12) Patent Application Publication
(10) Pub. No.: US 2009/0206229 A1
(43) Pub. Date: Aug. 20, 2009

(54) DUAL VIBRATION ISOLATION APPARATUS

(76) Inventor: Ivan Nesch, Crown Point, IN (US)

Correspondence Address: PAULEY PETERSEN & ERICKSON, 2800 WEST HIGGINS ROAD, SUITE 365, HOFFMAN ESTATES, IL, 60169, US

(21) Appl. No.: 12/372,397

(22) Filed: Feb. 17, 2009

Related U.S. Application Data
(60) Provisional application No. 61/065,916, filed on Feb. 15, 2008.

(51) Int. Cl. F16F 9/00

(52) U.S. Cl. 248/638

(57) ABSTRACT

An apparatus and method for vibrationally isolating two or more interconnected or mechanically cooperating imaging subsystems. A first of the subsystems can be an optics subsystem that includes optical components and other structural or mounting hardware for the optical components. A second of the subsystems can include, for example, an x-ray source, the object to be studied, and/or a detector. The apparatus includes at least two interconnected or mechanically coupled vibration isolation platforms. A component of the first of the subsystems is placed or mounted on one of the vibration isolation platforms and a component of the second of the subsystems is placed or mounted on the other of the vibration isolation platforms.

### CROSS REFERENCE TO RELATED APPLICATION

This application claims the benefit of U.S. Provisional Patent Application, Ser. No. 61/065,916, filed on 15 Feb. 2008. The co-pending Provisional Patent Application is hereby incorporated by reference herein in its entirety and is made a part hereof, including but not limited to those portions which specifically appear hereinafter.

### BACKGROUND OF THE INVENTION

1. Field of the Invention

This invention relates to an apparatus and method for isolating vibrations that affect subsystems within optical measurement and/or imaging systems or equipment.

2. Discussion of Related Art

The apparatus and method of this invention can be used with and generally relates to but is not limited to Diffraction Enhanced Imaging (DEI) systems, for example those taught by Chapman et al., U.S. Pat. No. 5,987,095 and Chapman et al., U.S. Pat. No. 6,577,708 and Wernick et al., U.S. Pat. No. 7,076,205. The apparatus and method of this invention can also be used, for example, to practice the crystal and imaging technology taught by Zhong et al., U.S. Pat. No. 6,038,285.

DEI is a radiographic technique that derives contrast from an object's x-ray absorption, refraction and ultra-small-angle scattering properties. DEI can be used to detect, analyze, combine and visualize the refraction, absorption and scattering effects upon an image of an object. DEI is particularly useful for relatively thick and thus highly absorbing materials. Compared to the absorption contrast of conventional radiography, the additional contrast mechanisms, refraction and scatter, of DEI allow visualization of more features of the object.

DEI can use highly collimated x-rays prepared by x-ray diffraction from perfect single-crystal silicon. These collimated x-rays are of single x-ray energy, practically monochromatic, and are used as the beam to image an object. The collimated x-rays are prepared by two silicon crystals of a monochromator. Once this beam passes through the object, another crystal of the same orientation and using the same reflection is introduced. This crystal is commonly called an analyzer. If this analyzer crystal is rotated about an axis, the crystal will rotate through a Bragg condition for diffraction and the diffracted intensity will trace out a profile that is called a rocking curve. At least two images are obtained by a detector at different angled positions, for example, one at each of the low and high angle sides of the rocking curve, of the crystal analyzer. The images are mathematically combined to obtain images, such as a refraction angle image.

The width of the rocking curve profile is typically a few microradians wide, for example 3.6 microradians within a full width of half maximum (FWHM) at 18 keV using a silicon (3, 3, 3) reflection. As with other radiographic imaging techniques, it is desirable to reduce or eliminate vibration throughout the system. Vibrations can be reduced by positioning the optics components or optical elements on a rigid vibration isolation platform, such as a single platform vibration isolation system that is commercially available from Kinetic Systems, Inc. (Boston, Mass.). Such vibration isolation systems may not be sufficient to hold or maintain a relative position of the imaging crystals, in order to obtain a successful overall performance for the entire machine or the entire system. There is an ongoing need for vibration-reducing optical tables to support imaging systems such as a DEI system.

### SUMMARY OF THE INVENTION

One object of this invention is to provide an apparatus and method of use for mechanically isolating, particularly isolating vibrations within, two or more interconnected or mechanically cooperating subsystems.

A first of the subsystems can be an optics subsystem that includes optical components and other structural or mounting hardware for the optical components. A second of the subsystems can include, for example, an x-ray source, the object to be studied, and/or a detector. In order to obtain successful results when using the entire system, during the method steps of this invention or during the experiments, both the first subsystem and the second subsystem should be stable, at least within themselves or each subsystem. Vibrations or other undesired forces caused by outside or external sources can be eliminated or minimized at least to the extent of not affecting performance of the subsystems. Instabilities or undesired vibrations or forces within any one or more of the subsystems can degrade the overall machine performance.

In certain embodiments of this invention, in the second subsystem, the components or elements, for example in a DEI machine or other optics system, an x-ray source, a sample holder, and/or a detector are kept or maintained at a precise spatial relationship or three-dimensional position with respect to each other. In order to maintain the precise spatial relationship or position with respect to each other, the components should be essentially free from and not moved by instabilities and/or vibrations induced from inside of or within each subsystem and/or from a surrounding environment or an outside vibration or instability. Thus, in certain embodiments of this invention, the components of each subsystem are placed or mounted on a separate, independent or individual vibration isolation platform, such as a rigid platform or mounting structure.

In some embodiments of this invention, both the x-ray source and/or the detector themselves can produce vibrations and instabilities, for example due to water cooling and other similar system functions. Even though the second subsystem may be rigid enough to provide a solid base to assure precise relative spatial relationship between the components of each subsystem, the vibrations created by the second subsystem components should also be prevented from propagating through the remainder of the system. If vibrations or instabilities are allowed to propagate to the first subsystem with the optics elements, then the source and/or the detector induced vibrations can significantly degrade or reduce the overall machine performance.

In certain embodiments of this invention, to prevent undesired vibrations and/or instabilities, the second subsystem is mechanically decoupled from or independent with respect to the first subsystem, and also does not receive vibrations and/or instabilities of the surrounding environment or the outside world that would affect the performance of the overall system. In some embodiments, the second subsystem, for example as applied to DEI, is inherently bigger in size than the first subsystem and the source can be at one end of the machine or system and the detector can be at the opposite end or relatively far away from the detector. Also, the sample holder can be part of the second subsystem and positioned between the optics components. Thus, a known single platform optical table, such as those that are commercially available, cannot be used to hold the second subsystem, for example in a DEI system.

In certain embodiments of this invention, a vibration isolation system comprises at least two interconnected, intertwined and/or mechanically coupled vibration isolation platforms. In each of the subsystems, the unintended interconnected or inter-component motions or vibrations should be significantly reduced while the collective motions or group motions of all of the subsystems can be tolerated to a much higher degree. Thus, with certain embodiments of this invention, the components and subsystems can move simultaneously, such as together as a whole or entire system because such entire movements, vibrations and/or instabilities of all of the subsystems will not noticeably degrade the overall system performance, as long as the components preserve or maintain their spatial relationships or three-dimensional positions within a subsystem.

In some embodiments, this invention comprises at least two independent vibration isolation tables or platforms working or cooperating together as an integrated or a structurally connected system. In some embodiments, an inner subsystem is within an area defined by a corresponding outer subsystem. The inner subsystem, for example, can comprise a conventional optical table. The outer subsystem, for example, can comprise a rigid bracket or other suitable structural member, completely surrounding the inner table or platform along or about a periphery of the inner vibration isolation table. At some point along and at equal distances from opposing edges there can be a rigid sample support bracket, which is part of the outer vibration isolation table. The position of the bracket can be selected to place or position the sample in the pathway of the x-ray beam and between two of the optical components.

The general object of the invention can be attained, at least in part, through a vibration isolation apparatus for optical measuring or imaging systems. The apparatus includes a first vibration isolation platform and a second isolation platform. The second isolation platform is mechanically disconnected or decoupled from the first vibration isolation platform. By supporting the first subsystem discussed above with the first vibration isolation platform and the second subsystem discussed above with the second vibration isolation platform, each of the two subsystems can be further isolated from any vibrations caused by the other.

Other objects and advantages will be apparent to those skilled in the art from the following detailed description taken in conjunction with the appended claims and drawings.

### BRIEF DESCRIPTION OF THE DRAWINGS

FIG. 1 is a partial sectional front view of a vibration isolation apparatus according to one embodiment of this invention.

FIG. 2 is a sectional perspective view of the apparatus of FIG. 1.

FIG. 3 is a top view of the apparatus of FIG. 1.

### DETAILED DESCRIPTION OF THE INVENTION

In one embodiment of this invention an apparatus is provided for mechanically isolating, particularly isolating vibrations within, two interconnected or mechanically cooperating subsystems. An exemplary first of the cooperating subsystems can be an optics subsystem wherein the optics components are maintained at a very precise spatial relationship or fixed position with respect to each other. Thus, the optical components should be essentially free from vibrations and other instabilities or external forces, for example inter-component instabilities caused by other machine components or external vibrations from a surrounding environment or the outside world.

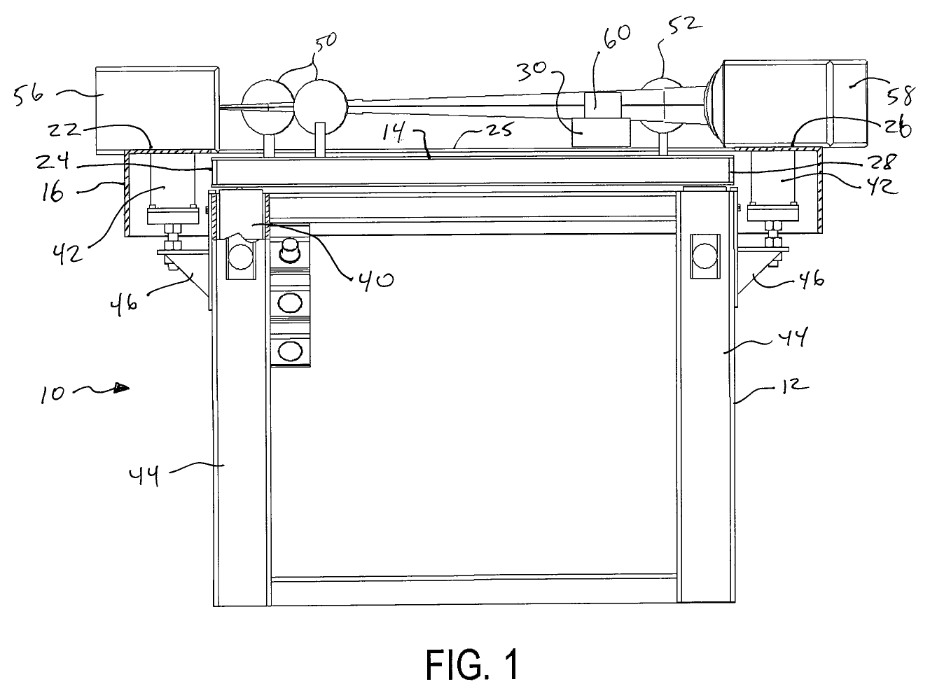

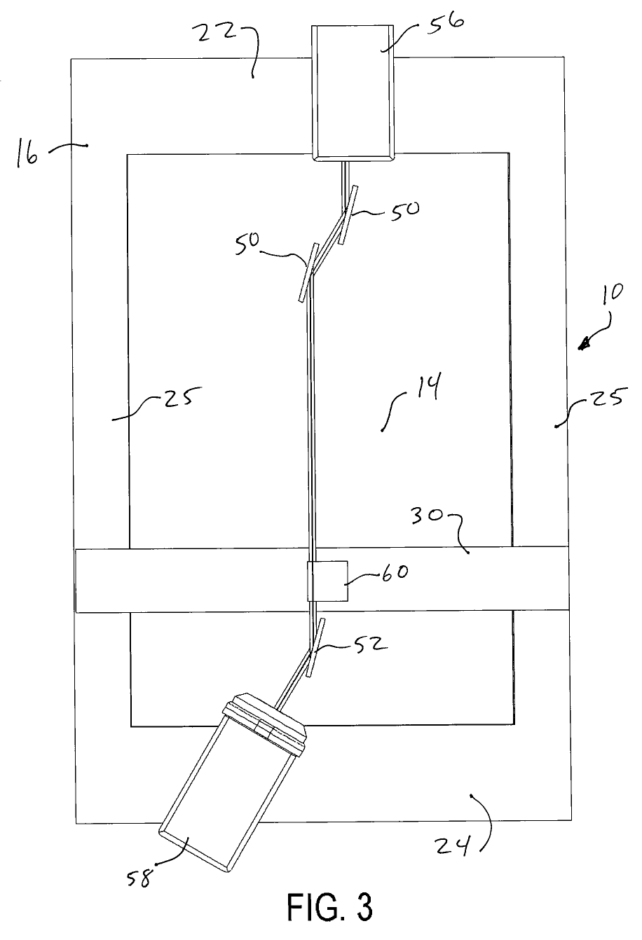

FIGS. 1-3 illustrate a vibration isolation apparatus 10 for use with optical measuring or imaging systems, such as the DEI systems discussed in Chapman et al., U.S. Pat. No. 5,987,095, Chapman et al., U.S. Pat. No. 6,577,708, and Zhong et al., U.S. Pat. No. 6,038,285, the teachings and disclosure of each of are incorporated into this specification by reference to such United States Patents. The vibration isolation apparatus 10 includes a support structure 12 supporting two interconnected or mechanically coupled vibration isolation platforms. The two vibration isolation platforms 14, 16 are kept or maintained mechanically disconnected or decoupled from each other and are also kept or maintained interconnected, intertwined or mechanically cooperating with each other through the independent connection of each platform 14, 16 to the support structure 12.

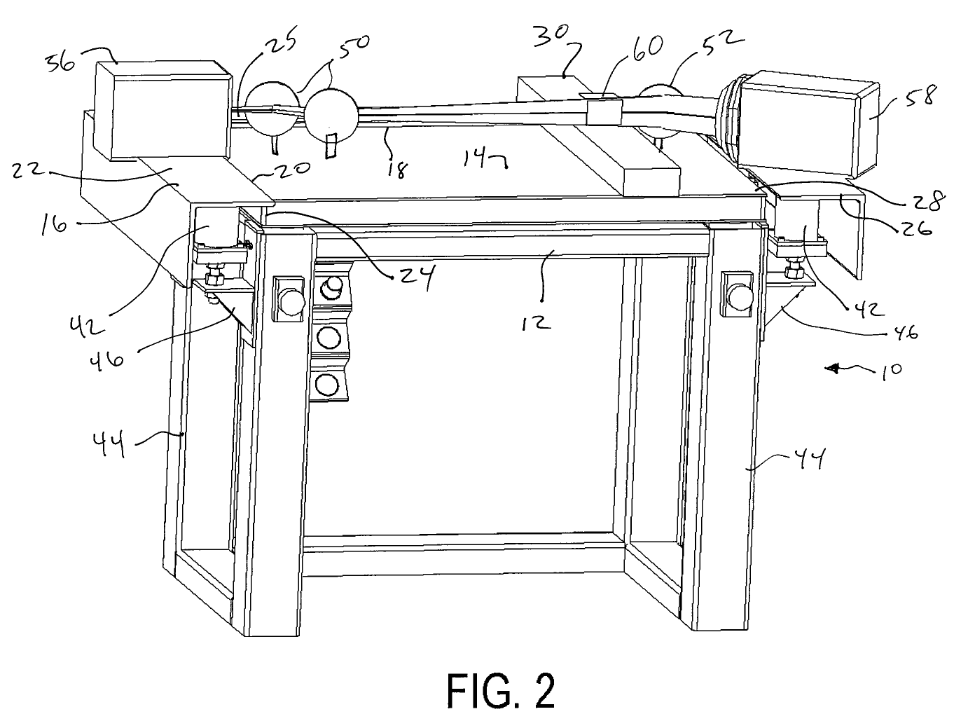

The two vibration isolation platforms 14, 16 can be made from materials currently used in commercial optical tables. For example, one or both of the vibration isolation platforms 14, 16 can be or include an optical breadboard, such as a hexagon cell steel honeycomb core structure below a top plate. The honeycomb structure can be used to impart high stiffness and a structurally efficient light weight, ultimately resulting in a significantly high natural frequency and less vibration than other materials such as solid granite or cast iron structures. On top of the honeycomb structure is, for example, a ferromagnetic stainless steel plate. Other materials for encasing the honeycomb structure (e.g., for a top, bottom layer and/or sides) include carbon steel; a high shear modulus, corrosion-resisting, plated steel; and/or an epoxy or other polymer. As shown in FIGS. 1-2, the second platform 16 is formed of a single layer steel plate. One or more of the isolation platforms 14, 16 can include a grid of threaded mounting holes (e.g., ¼ inch or M6 threaded holes) which allow the components to be bolted down to the platform so they cannot move even a few nanometers.

The support structure 12 can be similarly formed from known materials. Desirably the support structure 12 is formed from a rigid material such as steel. The support structure 12 is shown as a dedicated worktable support having legs 44 in the embodiment of FIGS. 1-2, but the invention is not so limited. The support structure can alternatively be an existing or dual-use table. The support structure can also be formed as a planar support structure that allows the apparatus of this invention to be formed as, for example, a leg-less breadboard for placement on an existing surface. The isolation platforms can be fixed to the support structure or removable, and/or the support structure can be designed to be further attachable to another structure (e.g., a floor or table).

The second vibration isolation platform 16 is held adjacent to and vibrationally isolated from the first vibration isolation platform 14. The second vibration isolation platform 16 is desirably held adjacent to at least a first end of the first vibration isolation platform 14. In one embodiment of this invention, as shown in FIGS. 1-3, the second vibration isolation platform 16 extends around and/or above a peripheral edge 18 of the first vibration isolation platform 14. The second vibration isolation platform 16 can have an inner edge portion that overlaps, is aligned with, or is laterally spaced apart from a portion of inner isolation platform. In FIGS. 1-3, the inner edge portion 20 of the second vibration isolation platform 16 is generally aligned with, but not overlapping, and above, e.g., spaced apart in a vertical direction from, the peripheral edge 18.

In the embodiment shown in FIGS. 1-3, the first vibration isolation platform 14 is formed as an inner platform to which components of a first subsystem are secured, and the second vibration isolation platform 16 is formed as an outer platform to which components of a second subsystem are secured. The size, shape, and/or configuration of the vibration isolation platforms can vary depending on need, which can be dependent on the type and number of components needed to be secured to or by the apparatus. For example, instead of extending around the inner platform, the outer platform can alternatively be formed as two separate platforms or platform portions disposed at the opposing ends of the inner platform.

In the embodiment of the invention shown in FIGS. 1-3, the second isolation platform 16 includes a first platform portion 22 adjacent to a first end 24 of the first vibration isolation platform 14 and a second platform portion 26 adjacent to a second end 28 of the first vibration isolation platform 14 that is opposite of the first end 24. The second isolation platform 16 includes at least one side portion 25 that extend along a side edge of the inner platform 14 to connect the first platform portion 22 with the second platform portion 26. The vibration isolation apparatus 10 includes an optional sample support 30 extending from one side portion 25, and optionally between two side portions 25, of the second isolation platform 16. The sample support 30 extends over the first isolation platform 14.

In certain embodiments of this invention, the inner platform and/or the outer platform is independently actively supported by suitable mechanical, electrical, magnetic and/or any other suitable element that provides vibration isolation support. For example, the cut-away view of FIGS. 1-2 illustrate a system according to one embodiment of this invention, in which first vibration dampening elements 40 are disposed between the support structure 12 and the first vibration isolation platform 14 and/or second vibration dampening elements 42 are disposed between the support structure 12 and the second isolation platform 16.

The vibration dampening elements 40, 42 are not intended to be limited to any particular dampening mechanism. In the embodiment shown in FIGS. 1-2, vibration dampening elements 40, 42 are shown as independent vibration eliminating cylinders, such as electrically, pneumatically or hydraulically operated cylinders. Each of these vibration eliminating cylinders is positioned near and mechanically coupled or operatively connected to each corresponding vibration isolation platform. In the particular embodiment of apparatus 10, one of the first vibration dampening elements 40 is disposed on each leg 44 of support structure 12 and between the corresponding leg 44 and a corner of the first vibration isolation platform 14. Each of the second vibration dampening elements 42 is connected to one of the legs 44 of support structure 12 by a bracket 46. In this arrangement, each subsystem corresponding with each vibration isolation platform is supported by a separate and independent vibration dampening mechanism, and moves completely independently from the other subsystem.

FIGS. 1-3 also illustrate the use of the apparatus 10 for supporting and mechanically and vibrationally isolating two interconnected or mechanically cooperating optical measuring or imaging subsystems. A first of the subsystems includes as optical components monochromator crystals 50 and analyzer crystal 52. A second of the subsystems includes a radiation source 56 and a detector 58. Each of the optical components is secured to the first vibration isolation platform 14. The second isolation platform 16 extends around the inner platform 14, thereby providing the first platform portion 22 for the radiation source 56 and the second platform portion 26 for the detector 58. The sample support 30 is formed as a part of the second vibration isolation platform 16, and thus the sample 60 thereon is considered part of the second subsystem.

By placing the optical components 50, 52 on the inner platform 14 between the radiation source 56 and the detector 58 of the outer platform 16, the two subsystems are vibrationally isolated from each other. In this component arrangement, vibrations or other undesired forces caused by outside or external sources can be eliminated or minimized at least to the extent of not affecting performance of the subsystems. In addition, instabilities or undesired vibrations or forces within any one or more of the subsystems can also be eliminated or minimized at least to the extent of not affecting performance of the subsystems. Thus, the invention provides a vibration isolation apparatus for use in interconnecting or mechanically coupling, while at the same time vibrationally isolating, components of optical measuring or imaging systems.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A vibration isolation apparatus for optical measuring or imaging systems, comprising at least two interconnected or mechanically coupled vibration isolation platforms.

2. The vibration isolation apparatus according to claim 1, comprising:
a first vibration isolation platform; and
a second isolation platform, wherein the second isolation platform is mechanically disconnected or decoupled from the first vibration isolation platform.

3. The vibration isolation apparatus according to claim 2, wherein the second vibration isolation platform is held adjacent to and vibrationally isolated from the first vibration isolation platform.

4. The vibration isolation apparatus according to claim 3, wherein the second isolation platform extends at least one of around or above a peripheral edge of the first vibration isolation platform.

5. The vibration isolation apparatus according to claim 2, wherein the second isolation platform is adjacent a first end of the first vibration isolation platform.

6. The vibration isolation apparatus according to claim 2, wherein the second isolation platform comprises a first platform portion adjacent to a first end of the first vibration isolation platform and a second platform portion adjacent to a second end of the first vibration isolation platform that is opposite of the first end.

7. The vibration isolation apparatus according to claim 6, wherein an edge portion of the first platform portion extends at least one of around or above an edge portion of the first end of the first isolation platform and an edge portion of the second platform portion extends at least one of around or above an edge portion of the second end of the first isolation platform.

8. The vibration isolation apparatus according to claim 6, wherein the second isolation platform comprises a side portion connecting the first platform portion and the second platform portion.

9. The vibration isolation apparatus according to claim 6, further comprising a sample support extending from the second isolation platform and over at least a portion of the first isolation platform.

10. The vibration isolation apparatus according to claim 1, further comprising a vibration dampening element disposed between a support structure and the first vibration isolation platform or the second isolation platform.

11. The vibration isolation apparatus according to claim 10, wherein each of the first vibration dampening element and second vibration dampening element comprises a vibration eliminating cylinder.

12. A vibration isolation apparatus for optical measuring or imaging systems, comprising:
a support structure;
a first vibration isolation platform connected to the support structure by a first connection; and
a second isolation platform mechanically disconnected or decoupled from the first vibration isolation platform and held adjacent to the first vibration isolation platform by a second connection to the support structure that is independent from the first connection of the first vibration isolation platform.

13. The vibration isolation apparatus according to claim 12, further comprising a vibration dampening element disposed between a support structure and at least one of the first vibration isolation platform or the second isolation platform.

14. The vibration isolation apparatus according to claim 12, wherein the second isolation platform extends at least one of around or above a peripheral edge of the first vibration isolation platform.

15. The vibration isolation apparatus according to claim 14, wherein the second isolation platform comprises a first platform portion adjacent a first end of the first vibration isolation platform and a second platform portion adjacent a second end of the first vibration isolation platform that is opposite of the first end.

16. A vibration isolation apparatus for optical measuring or imaging systems including two subsystems, the vibration isolation apparatus comprising at least two interconnected or mechanically coupled vibration isolation platforms, wherein a component of a first of the subsystems is placed or mounted on one of the vibration isolation platforms a component of a second of the subsystems is placed or mounted on an other of the vibration isolation platforms.

17. The vibration isolation apparatus according to claim 16, including in a first subsystem an optical component and in a second subsystem a radiation source and a detector, the vibration isolation apparatus comprising:
a first vibration isolation platform, at least a portion of the first subsystem being supported by the first vibration isolation platform; and
a second isolation platform mechanically disconnected or decoupled from the first vibration isolation platform, at least a portion of the second subsystem being supported by the second vibration isolation platform.

18. The vibration isolation apparatus according to claim 17, further comprising a vibration dampening element disposed between a support structure and at least one of the first vibration isolation platform or the second isolation platform.

19. The vibration isolation apparatus according to claim 17, wherein the second isolation platform comprises a first platform portion adjacent a first end of the first vibration isolation platform for securing the radiation source thereto and a second platform portion adjacent a second end of the first vibration isolation platform that is opposite of the first end for securing the detector thereto.

20. The vibration isolation apparatus according to claim 19, wherein the optical component is secured to the first vibration isolation platform between the radiation source and the detector.
